(19) United States
(12) Patent Application Publication
(10) Pub. No.: US 2015/0303010 A1
(43) Pub. Date: Oct. 22, 2015

(54) A VACUUM INTERRUPTER AND A VACUUM CIRCUIT BREAKER HAVING THE SAME

(71) Applicants: Li YU, Shanghai (CN); EATON CORPORATION, Cleveland, OH (US)

(72) Inventor: LI YU, PITTSBURGH, PA (US)

(73) Assignee: EATON CORPORATION, CLEVELAND, OH (US)

(21) Appl. No.: 14/648,974

(22) PCT Filed: Nov. 28, 2013
(86) PCT No.: PCT/CN2013/088030

§ 371 Date: Jun. 2, 2015

(30) Foreign Application Priority Data
Dec. 14, 2012 (CN) 201210544572.7

(51) Int. Cl. H01H 33/666

(52) U.S. Cl. CPC H01H 33/666; H01H 2205/002; H01H 2235/01

(57) ABSTRACT

In the present invention a vacuum interrupter is provided, comprising: a housing; a fixed contact received in the housing; a movable contact received in the housing and configured to be movable to engage with or disengage from the fixed contact; a conductive seat fixedly mounted in the housing and configured to maintain an electrical connection with the movable contact; a flexible electrical connection feature received in the housing for connecting the movable contact with the conductive seat; and an operating mechanism for actuating the movement of the movable contact. In the present invention a vacuum circuit breaker having the above-mentioned vacuum interrupter is also provided.

### TECHNICAL FIELD

The present invention relates to a vacuum interrupter, especially relates to a vacuum interrupter for a vacuum circuit breaker. Moreover, the present invention also relates to a vacuum circuit breaker.

### BACKGROUND

A vacuum interrupt is the key element of a vacuum switch or a vacuum circuit breaker for controlling the electrical arc. Switching on and switching off of current and electrical arc are realized by the movement of contact in the vacuum interrupter. Nowadays, the vacuum interrupter mainly includes the following components, i.e., a movable contact, a fixed contact and conductive rods for the movable and fixed contacts, an insulation housing, a shield, bellows and the like. For instance, the CN utility model patent ZL 200520034035.3 discloses a conventional vacuum interrupter. The existing movable contact conductive rod is configured to conduct the current through the moveable contact on one hand, and on the other hand serves as actuating means for moving the movable contact to disengage from the fixed contact. In the vacuum interrupter, for conducting the current, it is preferred to maximize the surface area of the movable contact conductive rod to facilitate heat dissipation, whereas to improve the efficiency of the vacuum interrupter and the reliability of the vacuum circuit breaker, it is desirable to effectively minimize the mass of the moving components including the movable contact conductive rod. Therefore, the existing movable contact conductive rod has to compromise in these two points.

Moreover, to improve short-circuit current interrupting capacity of the vacuum interrupter, a technology of controlling vacuum electrical arc magnet field has been developed. It has been found that the magnet field generated by the current can effectively facilitate interruption of the electrical arc during switching off the movable and fixed contacts, so as to rapidly extinguish the arc. In the prior art multiple methods have been developed to enhance the magnet field. One of the conventional means is to form spiral grooves in the contacts (including the movable and fixed contacts), prolonging the current path in the movable contact to enhance the magnet field. However, as the distance between the movable contact and the fixed contact increases, the magnet field will decrease significantly as the separated distance increases to be insufficient to control the electrical arc in the large separated distance. The spiral grooves can provide little help to prevent such a magnet field decrease.

Therefore, the inventor intends to improve the prior art to provide a vacuum interrupter as well as a vacuum circuit breaker having the same which can at least partially overcome the above deficiencies in the prior art.

### DESCRIPTION OF THE INVENTION

According to one aspect of the invention, a vacuum interrupter is provided which comprises: a housing; a fixed contact received in the housing; a movable contact received in the housing and configured to be movable to engage with or disengage from the fixed contact; a conductive seat fixedly mounted in the housing and configured to maintain an electrical connection with the movable contact; a flexible (soft) electrical connection feature received in the housing for connecting the movable contact with the conductive seat; and an operating mechanism for actuating a movement of the movable contact.

As compared with the known conductive rod which is used for electrical connection with movable contact and also serves as the operating mechanism for the movement of the movable contact, the vacuum interrupter of the present invention provides a flexible electrical connection feature such that the electrically conductive member which is electrically connected with the movable contact and the operating mechanism for the movable contact are configured separately, such that the electrically conductive member, i.e. the conductive seat, may be designed having a bigger size for facilitating the heat dissipation of the vacuum interrupter, while the mass of movable components in the vacuum interrupter will not increase significantly or even will decrease. In addition, the operating mechanism may be made of more various materials. For example, it is possible to utilize the materials which have lighter weight or a better heat dissipation.

According to an embodiment of the invention, the conductive seat may be in form of a hollow member with a central through-hole. The operating mechanism may include an operating rod in rigid connection with the movable contact, and an actuator configured to move at least the operating rod and the movable contact to disengage from the fixed contact, wherein the operating rod passes through the central through-hole. By means of such an arrangement, the conductive seat may advantageously have an outer and inner heat dissipation surfaces. Moreover, the conductive seat may advantageously have an interior space for receiving other components of the vacuum interrupter, such as the bellows and contact springs, such that a more compact design of the vacuum interrupter is provided.

According to an especially preferable embodiment of the invention, the flexible electrical connection feature includes at least one flexible conductive strip arranged between the movable contact and the conductive seat, and the flexible conductive strip is arranged inclinedly relative to a longitudinal axis of the movable contact, or helically around the longitudinal axis.

As mentioned above, in the existing vacuum interrupter, as the separated distance of the movable and fixed contacts increases, the longitudinal magnet field generated between the movable contact and the fixed contact decreases, which is detrimental to the breaking ability of the movable and fixed contacts. By means of the inclined or helical arrangement of the flexible conductive strip in the preferable embodiment of the present invention, as the separated distance of the movable and fixed contacts increases, the inclined or helical angle of the flexible conductive strip relative to the plane of the movable contact longitudinal axis decreases accordingly. Therefore, a component of the current that produces the longitudinal magnet field increases, such that the magnet field will decrease little or in some cases will maintain unchanged or even increase as the separated distance increases. Therefore, the decrease of the inclined or helical angle can cause a positive effect that the magnet field generated between the movable contact and the fixed contact will not decrease inversely proportional to the increase of the separated distance, such that the breaking ability of the movable and fixed contacts is improved.

According to a further preferable embodiment of the invention, the at least one flexible conductive strip comprises a plurality of flexible conductive strips. Preferably, the plurality of flexible conductive strips have a consistent inclined or helical direction which will produce a superimposed effect of enhancing the longitudinal magnet field.

It should be appreciated by the person skilled in the art that the conductive seat may perform a functionality of conduction similar to the prior art conductive rod, such that during the switching on (engagement) or switching off (disengagement) of the movable and fixed contacts, the conductive seat keep in an electrical connection with the movable contact, and as known in the art, the conductive seat may be connected to a corresponding electrical element of the vacuum interrupter or the vacuum circuit breaker via terminals.

In some embodiments of the invention, the electrical connection between the conductive seat and the movable contact can be substantively provided by the flexible electrical connection feature, no matter when in the switching on or in the switching off.

In an alternative, preferable embodiment of the invention, the operating rod comprises a switching-on conductive feature in contact or connection with the movable contact, wherein the switching-on conductive feature is configured to electrically connect with the conductive seat when the movable contact engages with the fixed contact, and to electrically disconnect or be separated from the conductive seat when the movable contact disengages from the fixed contact. During switching on of the movable and fixed contacts, therefore, most of or substantially all the current of the movable contact flows through the switching-on conductive feature to the conductive seat. As an explanation but not limitation, this may be because the operating rod has a shorter conductive path and/or a greater conductive section than the flexible strips. It should be appreciated by the person skilled in the art that the switching-on conductive feature may be made of a conductive material same as or different from that of the flexible electrical connection feature, although the conductivity of the conductive material of the switching-on conductive feature is preferably not worse than that of the flexible electrical connection feature. When the movable and fixed contacts switch off, the switching-on conductive feature will disengage or be separated from the conductive seat, such that most of or all the current of the movable contact is conducted by the flexible electrical connection feature. The switching-on conductive feature of the invention not only has a current conductive capacity same as or even better than the prior art design during switching on, and may obtain the merits provided by the flexible electrical connection feature during switching off, such as an increased heat dissipation surface, decreased mass of movable components and/or decreased inclined or helical angle for relatively enhancing the longitudinal magnet field.

According to a particular embodiment of the invention, the switching-on conductive feature is provided, including a flange protruding from the rod body of the operating rod. The central through-hole of the conductive seat has a first opening portion such as an upper opening portion with a smaller diameter and a second opening portion such as a lower opening portion with a greater diameter. The flange has a shape at least partially corresponding to the first opening portion. Therefore, the flange at least partially or preferably engages with the first opening portion during switching on. During switching off, as the operating rod moves e.g., downwards relative to the conductive seat, the flange moves into the second opening portion with the greater diameter so as to be spaced from the conductive seat.

According to another particular embodiment of the invention, a switching-on conductive feature is provide which similarly defines a flange protruding from the rod body of the operating rod, and the central through-hole of the conductive seat accordingly defines a first contacting portion and a second insulating portion. Therefore, during switching on, the flange is positioned to contact with the first contacting portion, while during switching off, the flange moves into the second insulating portion and thus is electrically insulated from the conductive seat. The second insulating portion may comprise an annular insulating sleeve mounted to the wall of the central through-hole or insulating material layer or integrated with the wall of the hole.

Although two specific switching-on conductive features are described, other kinds of configuration are still possible, as long as it is able to form main current path through the operating rod during switching on and cut off the current path through the operating rod during switching off. For example, the central through-hole of the conductive seat can be configured to be tapered towards the movable contact, and the corresponding portion of the operating rod is conductive and is configured to be tapered too, such that the tapering surfaces of the conductive seat and the operating rod engage with each other during switching on, while during switching off, as the operating rod moves downwards, a gap is formed between the two tapering surfaces such that the two tapering surfaces are spaced from each other. Moreover, it should be appreciated by the person skilled in the art that the switching-on conductive feature may be generally formed on the upper portion of the conductive rod and comprise or consist of the conductive material, while other portions of the conductive rod such as the lower portion may as desired have the same or different material.

According to one preferred embodiment of the invention, in the case that the flexible electrical connection feature includes a plurality of flexible conductive strips, the vacuum interrupter may further comprise a separating support for supporting and separating at least some, or preferably all, of the plurality of flexible conductive strips. Therefore, during switching on, contact and engagement between the adjacent flexible conductive strips can be reduced or avoided, which otherwise may shorten the path flowing through the flexible electrical connection feature during switching on and thus is detrimental to the ability of the inclinedly or helically flexible conductive strips to improve the longitudinal magnet field. According to a further preferable embodiment, the separating support may be mounted onto or integral with the conductive seat. It, however, should be appreciated by the person skilled in the art that the separating support may have an electrical resistance greater than that of the flexible electrical connection feature, or the separating support may make no contact with or is in insulation from the conductive seat, such barely no or little current flows to the conductive seat through the separating support. In a preferable embodiment, the separating support is made of stainless steel.

According to a particular embodiment of the invention, the separating support may have a plurality of circumferentially arranged holes, one flexible conductive strip passing through each hole.

According to another particular embodiment of the invention, the separating support may have a plurality of radially extending radial bars, wherein a space is defined between the two adjacent radial bars. Preferably, one flexible conductive strip passes through each space.

It should be appreciated by the person skilled in the art that the prior art bellows maybe combined in all embodiments of the present invention, and the prior art bellows may be configured relative to the operating rod in a way as known in the prior art, which can be achieved by the embodiments of the invention and fall into the scope of the present invention. For example, one end of the bellows is in peripherally sealing connection with the operating rod, and the other end is in sealing connection with the outside or inside of the housing around a portion of the operating rod to be extended outside the housing.

Alternatively, according to a particularly preferable embodiment of the invention, one end of which is in peripherally sealing connection with the operating rod, and the other end is in peripherally sealing connection with the central through-hole, e.g., with the first opening portion of the central through-hole, to define a vacuum space within the housing. By means of such arrangement, the interior of the bellows is in vacuum. Because the bellows can inherently bear a greater external pressure, such arrangement of the bellows may allow a longer service life. In addition, by means of such arrangement of the bellows, the end of the bellows which is in sealing connection with the operating rod may be the lower end far away from the movable contact, while the end of the bellows which is in sealing connection with the conductive seat is the end near to the movable contact, such that the bellows is normally maintained in contraction or compression during the switching on, and stretches only during switching off, which may significantly prolong the service life of the bellows.

According to a preferable embodiment of the invention, a bellows bush is mounted inside the bellows so as to prevent the electrical arc from burning the bellows through the central hole of the conductive seat which will otherwise cause leakage. It is desired that the bellows bush is mounted to the conductive seat around the first opening portion.

It should be appreciated by the person skilled in the art that the prior art contact spring can be combined in all embodiments of the present invention, and the prior art contact spring may be configured relative to the operating rod in a known way, all of which can be achieved in the embodiments of the invention and fall into the scope of the present invention. According to a preferable embodiment of the invention, for example, one end of the contact spring may rest against the operating rod and the other end may rest against the fixed part of the housing. According to an example, the operating rod forms a stopping portion extending radially from the rod body for abutting against the upper end of the spring. In the housing a fixture is mounted for abutting against the lower side of the spring. According to another example, a stopping portion of the operating rod abuts against the lower end of the spring, and the conductive seat forms another stopping portion extending inwards from the central hole for abutting against the upper end of the spring. Moreover, a variety of contact spring arrangements are possible.

According to a preferred embodiment of the invention, the hollow conductive seat may define a receiving groove which receives the bellows and/or the spring, so as to provide a compact arrangement. According to an example, the receiving groove is of the second opening portion of the central through-hole, although the receiving groove may be formed separately from the second opening portion. Also, other arrangements are conceivable.

According to an embodiment of the invention, the vacuum interrupter may further include a second interior shield inside the housing. Some prior art designs also have an interior shield which receives the fixed contact, the movable contact and a portion of the conductive seat in the vacuum condition. However the interior shield of the invention receives the flexible electrical connection feature and a portion of the conductive seat, preferably the portion of the conductive seat which is connected to the flexible electrical connection feature. The above-mentioned vacuum space is mainly formed by the interior shield (as well as the interior space of the bellows in some embodiments).

According to another aspect of the invention, a vacuum circuit breaker is provided which comprises at least one vacuum interrupter according to the invention. It should be appreciated by the person skilled in the art that in addition to the vacuum interrupter according to the invention, the vacuum circuit breaker according to the present invention may have any suitable vacuum circuit breaker components known in the prior art or developed in the future. In other words, the vacuum interrupter according to the invention may be employed in the vacuum circuit breaker known in the prior art or developed in the future, in order to replace its vacuum interrupter, which fall within the scope of the invention.

Parts of other features and advantages of the present invention will be illustrated in the below description with reference to the accompanying drawings, and other parts will be apparent to the persons skilled in the art after reading the disclosure.

### BRIEF DESCRIPTION OF THE DRAWINGS

The embodiments of the invention will be described in detail with reference to the accompanying drawings, in which:

FIG. 1 illustrates the vacuum interrupter according to the first embodiment of the invention;

FIG. 2a and FIG. 2b illustrate the vacuum interrupter according to the second embodiment of the invention;

FIG. 3a illustrates the flexible electrical connection feature according to an embodiment of the invention, when the movable contact engages with the fixed contact;

FIG. 3b illustrates the flexible electrical connection feature of FIG. 3a when the movable contact disengages from the fixed contact;

FIG. 4a illustrates the components of the vacuum interrupter of FIG. 2, when the movable contact engages with the fixed contact;

FIG. 4b illustrates the relative positions of the components of FIG. 4a when the movable contact disengages from the fixed contact;

FIG. 5 is the detailed view of FIG. 4b, specifically showing the switching-on conductive feature according to one embodiment of the invention; and

FIG. 6 illustrates the separating support according to one embodiment of the invention.

In the present invention, the same reference numerals represent the same or similar features or components.

### DETAILED DESCRIPTION OF THE EMBODIMENTS

The embodiments of the invention will be further described in the following detailed description with reference to the accompanying drawings. Although the drawings are provided for the purpose of illustrating the particular embodiments of the invention, it is not necessary to present the drawings in scale, in which some features may be exaggerated, removed or sectioned in order to better illustrate the invention.

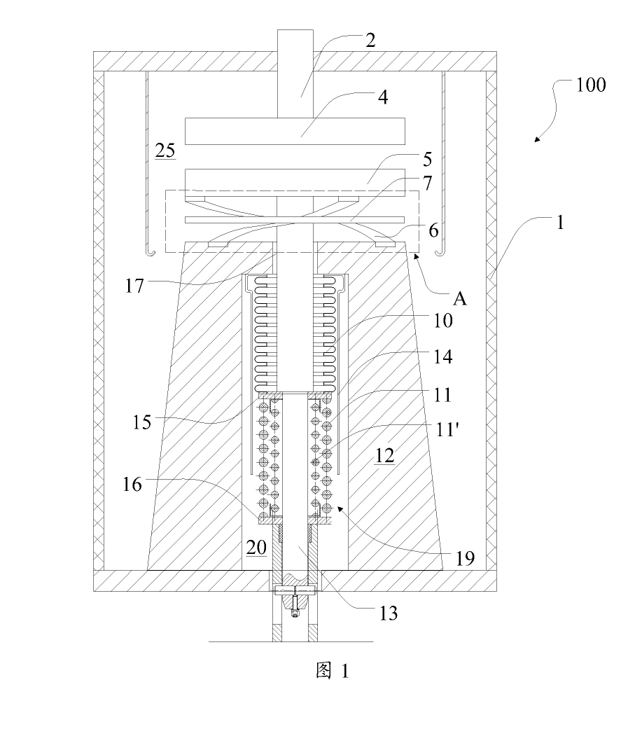

Referring to FIG. 1, showing a vacuum interrupter 100 according to the first embodiment of the invention. The vacuum interrupter 100 may comprise a housing 1, a fixed contact 4 and movable contact 5 mounted within the housing 1. As illustrated, the vacuum interrupter 100 may further comprise a fixed contact conductive rod 2 which is in rigid connection with the fixed contact. The fixed contact conductive rod may be connected to a corresponding electrical element as is disclosed in the art, in such way current transfer is realized during switching on of the fixed contact 4 and the movable contact 5 as well as the early stage of switching off of the fixed contact 4 and the movable contact 5 (i.e., when the electrical arc has not been cut off).

The fixed contact 4, the movable contact 5 and the fixed contact conductive rod (or referred to as “fixed conductive rod”) 2 may function and/or move in a manner known in the art. As an example, the fixed contact and the fixed conductive rod are of static, while the movable contact moves in its axial direction so as to engage with the fixed contact (switching on) or disengage from the fixed contact (switching off). As mentioned above, at the early stage of switching on, the breakdown occurs across the air between the movable contact and the fixed contact(separated distance)such that electrical arc is generated. The electrical arc will decrease gradually as the contact separation increases, and thus will be extinguished at the end. Although not specifically indicated in the invention, the fixed contact 4, the movable contact 5 and the fixed contact conductive rod 2 may be in any known or other suitable form and/or may be made of any known or other suitable material. For example, they may all be made of copper, although they may be made of any other same or different materials. Moreover, the fixed contact 4 and movable contact 5 may be provided with some given functional structures and features so as to achieve the given technical effects. For example, the fixed contact 4 and the movable contact 5 may be in form of a disk contact, although they may be other kinds of contact member. The fixed contact and the movable contact may both be equipped with spiral grooves for prolonging the current path, such that the cut-off (switching-off) magnet field can be enhanced.

As mentioned above, the invention is directed to the improvement of the movable components of the vacuum interrupter, while the overall configuration and functionality of a vacuum interrupter is known in the art. Therefore, it would be appreciated by the person skilled in the art that the embodiments of the invention may be combined with some other components of the vacuum interrupter in the art in a manner that no inconsistence occurs, or some conventional components as described herein may be suitably replaced with the corresponding components in the art, so as to yield new embodiments.

Still referring to FIG. 1, the movable components(i.e. the components related to the movable contact) of the vacuum interrupter according to an embodiment of the invention will be discussed below in detail.

As mentioned above, to move the movable contact, the prior art vacuum interrupter just utilizes a movable contact conductive rod in rigid and electrical connection with the movable contact, and then the movable contact conductive rod (or referred to as “movable conductive rod”) is connected to a corresponding electrical element such as a terminal or the like, to create current path. Therefore, the movable contact conductive rod in the prior art may move the movable contact in axial direction to engage with or disengage from the fixed contact. The use of such a movable conductive rod has to be compromised in maximizing the surface area for heat dissipation and in minimizing the mass of movable components.

To this end, the invention provides an arrangement of improved movable components (the components on the movable contact side). As illustrated in FIG. 1, the vacuum interrupter may also comprise an operating rod 13 rigidly connected to the back side of the movable contact, a movable contact conductive seat 12 fixedly mounted in the housing 1, and a flexible (soft)electrical connection feature between the movable contact 5 and the movable contact conductive seat 12. As illustrated in FIG. 1, the movable contact conductive seat 12 is in the form of a hollow member with a central through-hole 20, through which the elongated operating rod 13 passes and is connected to the movable contact 5. Although not illustrated in the figures, it would be appreciated by the person skilled in the art that in addition to the operating rod 13, the vacuum interrupter 100 may also comprise an actuator for actuating the operating rod to move together with the movable contact in the axial direction. As illustrated in the figures, the movable contact 5, the movable contact conductive seat 12 and the operating rod 13 may be aligned substantially coaxially.

According to the disclosure, it would be appreciated by the person skilled in the art that the operating rod 13 may function as operating and thus moving the movable contact, as is the known movable conductive rod, while the movable contact conductive seat 12 may function as providing a current path through the movable contact, the conductive seat and other electrical elements at least during the disengagement of the fixed contact 4 and the movable contact 5. The movable contact conductive seat 12 also forms a surface for heat dissipation of the switching-off current. As compared with the prior art, The operating rod 13 of the disclosure may be made of a wider variety of materials and has a higher degree of freedom in selection of its dimension and mass more, as long as the operating rod 13 which is in rigid connection with the movable contact 5 has sufficient strength to withstand the force produced during the engagement and disengagement of the fixed contact and the movable contact (such as during the life time). Also, the operating rod may for example use the lighter and/or cheaper materials, although the material same as that of the moveable conductive rod in the art may also be possible. Furthermore, the operating rod may have a smaller size.

Accordingly, the movable contact conductive seat 12 which forms at least part of the (main) current path during the switching off (i.e., when the movable contact moves and disengages from the fixed contact) may need not to make much consideration in its moving mass, such that it may be made bigger with a lager heat dissipation surface and thus a better heat dissipation effect. Since the movable contact conductive seat 12 performs the conductive function similar to the known conductive at least during the switching off, the conductive seat 12 may have or consist of the same material such as copper as the known conductive rod, although any suitable conductive materials may be utilized.

In the embodiments illustrated in FIG. 1, the conductive path between the movable contact conductive seat 12 and the movable contact 5 is provided by a flexible electrical connection feature at least during the switching off. As illustrated in the area A of FIG. 1, the flexible electrical connection feature may comprise a plurality of conductive strips 6, one ends of which are connected to the back side of the movable contact 5, and the other ends are connected to the top side of the conductive seat 12, such that the conductive strips are arranged in the space between the movable contact 5 and the conductive seat 12, as discussed below in detail.

Bearing the teaching of the invention in mind, the person skilled in the art may conceive of different kinds of flexible electrical connection feature, as long as it allows the movement of the movable contact relative to the conductive seat and at the same time maintains the (conductive) connection between the movable contact and the conductive seat. The flexible electrical connection feature may use various suitable conductive materials, including those same as or different from that of the fixed contact, the movable contact, fixed conductive rod or conductive seat, such as strips made of soft copper.

In the embodiment of FIG. 1, the flexible electrical connection feature constitutes a part of the main current path during both the switching on and the switching off of the fixed contact 4 and the movable contact 5, such that the current of the fixed contact 4 flows substantially through the flexible electrical connection feature to the conductive seat 12. In some other embodiments of the invention, however, the main current path 26 during switching on will not pass through the flexible electrical connection feature which will physically connect the movable contact with the conductive seat all the time, as discussed below in detail.

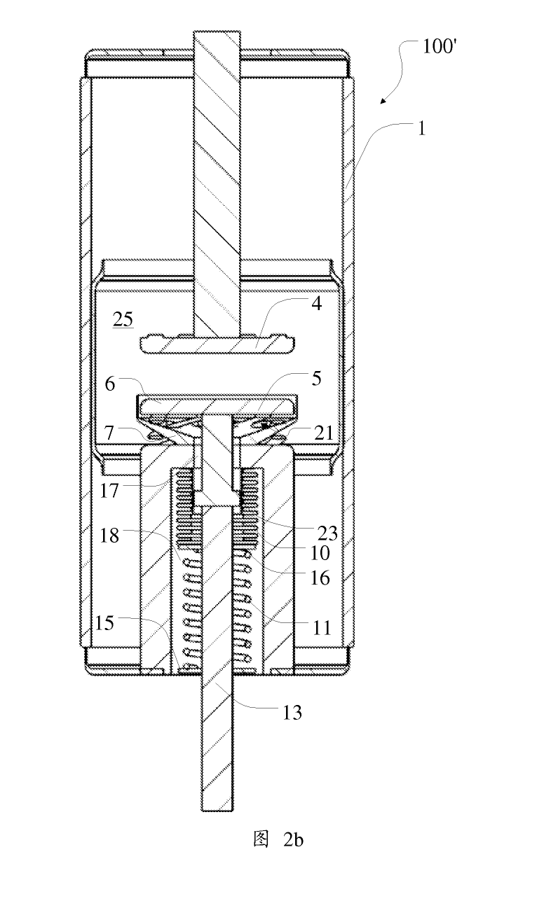

Referring to FIG. 3a and FIG. 3b, a preferred embodiment of the flexible electrical connection feature as shown in the area A of the FIG. 1 will be discussed below. FIG. 3a and FIG. 3b are schematic views of the area A of FIG. 1, and therefore the components of the invention are not necessarily configured to have the arrangement, dimension parameters or scale exactly corresponding to what they illustrate. In the arrangement as shown in FIG. 3a, the fixed contact 4 and the movable contact 5 are in engagement with each other, while FIG. 3b illustrates that the fixed contact 4 and the movable contact 5 disengage from each other. As shown in FIG. 3a and FIG. 1, a plurality of conductive strips 6 are arranged helically in a consistent helical direction (counterclockwise from the movable contact to the conductive seat as viewed from the top of the movable contact) about the axis of the movable contact—i.e., the axis of the conductive seat or the operating rod, and have the same or substantially the same helical angle α. As the movable contact 5 disengages and moves away from the fixed contact 4 in the axial direction, the helical angle α will decease accordingly, as shown in FIG. 3b.

As an explanation but not constituting limitation, the inventor finds that in the known vacuum interrupter, as the separated distance of the fixed contact and the movable contact increases, the longitudinally magnetic field generated by the current will decrease accordingly, degrading the cut-off ability, as mentioned above. As the helical angle α of the flexible conductive strips according to the invention decreases, the horizontal component of a given current intensity will increase, so as to generate a stronger longitudinally magnetic field. Therefore, the arrangement in the disclosure is able to reduce or even eliminate the degradation of the magnet field and thus the decrease of the cut-off ability caused by the increase of the separated distance, such that a relatively great longitudinal magnet field can be provided even as the separated distance increases. Therefore, such arrangement in the disclosure will have a positive effect on the magnet field and the cut-off ability of the vacuum interrupter.

In the disclosure, the above-mentioned helical angle may be measured in a projection developed plane of the cylindrical surface which has the longitudinal axis of the movable contact as the center line, and may be determined by the included angle between the flexible conductive strips 6 and a plane perpendicular to the said longitudinal axis (i.e., a horizontal plane in the illustrated embodiment and in the embodiments in which the vacuum interrupter is vertically oriented). In some other embodiments of the invention, however, the flexible conductive strips are arranged obliquely between the movable contact and the conductive seat, such that as the movable contact disengages and moves away from the fixed contact, the inclined angle, which is determined by the inclined angle of the flexible conductive strips relative to the above-mentioned plane (such as the horizontal plane), will decrease accordingly.

In this case, it should be appreciated by the person skilled in the art that the decrease of the helical or inclined angle means that as the movable contact moves away from the fixed contact, the overall angle of the flexible conductive strip, rather than every helical or inclined angle at each point of the flexible conductive strip 6, will decrease (it is can be seen from FIG. 3b that the overall angle decreases rather than the angles at each point decrease). It should be appreciated by the person skilled in the art that in some embodiments of the invention, especially in engineering practice, as the movable contact moves away from the fixed contact, the flexible conductive strips 6 may not present a perfect helical arrangement or a perfect inclined arrangement, nor have an ideally helical or inclined angle decrease, but rather they may assume a combination of the helical and inclined arrangements.

Based on the geometry theory, as an explanation but not constituting limitation, as the movable contact moves away from the fixed contact in the axial direction, in the helical and/or inclined flexible conductive strips the vertical component (axial component) of the vector of the current flowing through the flexible conductive strips will decrease accordingly, while the horizontal component will increase or remain substantively unchanged. Thus the ratio of the vertical component to the horizontal component (the tangent value of the helical and/or inclined angle) will decrease accordingly, such that in general the helical angle or the inclined angle or their combination will tend to decrease, such that the horizontal component of the current will increase accordingly, producing a positive effect on reducing the degradation of the magnet field or enhancing the magnet field. Therefore, any helical arrangement, inclined arrangement or their combination of the flexible conductive strips will fall within the scope of the invention, as long as the helical or inclined arrangement may lead to the said angle decrease which in turn produces the positive effect on the magnet field accordingly.

In view of these, it should be appreciated by the person skilled in the art that the flexible conductive “strips” of the invention may have various dimensions, configurations and shapes as desired, and may be inform of cables, tapes and threads, as long as they are able to realize the effects of the invention. The various kinds of flexible conductive strips fall within the scope of the invention.

In a preferred embodiment of the invention, the flexible conductive strips are evenly arranged about the movable contact or the operating rod, so as to provide a homogeneous combustion of electrical arc on the movable contact and improve the efficiency of the contact.

Referring to FIG. 1, in some preferred embodiments of the invention, a separating support 7 is provided, for facilitating the functionality of the plurality of flexible conductive strips 6. In the embodiments of the invention, the separating support 7 is configured to separate at least some, or preferably all, of the flexible conductive strips 6 from each other. It is preferred that the separating support 7 is spaced from the conductive seat 12, or has an electric resistance significantly greater than that of the flexible conductive strips and the conductive seat. In an example, the separating support 7 is of a stainless steel member.

In some embodiments, the separating support 7 is configured such that at least during switching off it will not transfer significant current which will be otherwise detrimental to the performance of the flexible conductive strips. In the illustrated embodiments, the separating support 7 is fixed onto the operating rod 13, although the separating support may be fixed to other components, as long as it is able to advantageously separate the, e.g., adjacent, flexible conductive strips from each other. It should be understood that the separating support discussed in other parts of the specification may be replaceably combined in various embodiments of the invention and mounted onto various suitable components.

As illustrated in FIG. 1, according to an advantageous arrangement of the invention, the central through-hole 20 of the hollow conductive seat 12 defines a receiving groove 19, which may receive not only a portion of the operating rod but also some other components of the vacuum interrupter 100, such that a compact vacuum interrupter is made. In the embodiment illustrated in FIG. 1, the conductive seat 12 forms a first opening portion 17 adjacent to the top portion thereof, which has a radial dimension smaller than that of the receiving groove and is in communication with the receiving groove 19, as discussed below in detail.

The embodiment of FIG. 1 particularly shows a preferred configuration of bellows, although it should be appreciated by the person skilled in the art that the prior art bellows and its configuration may be combined in the embodiments of the invention to yield new embodiments. In the embodiment, the bellows 10 is configured to peripherally seal around the operating rod 13. More specifically, the operating rod 13 has a stopping portion 15 extending from the rod body therefore, with a first end of the bellows being sealingly connected to the stopping portion 15 (bellows). Contrary to the prior art arrangement which seals around the housing opening for the moveable conductive rod, a second end of the bellows 10 in the embodiment peripherally seals around the central through-hole 20 of the conductive seat 12. More specifically, the second end surrounds the top opening portion 17 of the central through-hole 20 such that a simple installation and sealing are provided. By means of such sealing of the bellows 10 with the operating rod as well as the conductive seat, formed within the housing 1 is a vacuum space 25, and the interior of the bellows 10 also constitutes part of the vacuum space, such that the bellows withstands the atmospheric pressure on its outer side. In terms of the inherent property of the bellows, such externally pressure-bearing configuration has longer service life as compared with the prior art configuration which withstands the atmospheric pressure on its inner side. In addition, at the normal (switching-off)condition of the vacuum interrupter, the bellows is in compression or contraction. As compared with the conventional design in the prior art in which the bellows is in stretching or tensional condition, the compression or contraction of the bellows make it less possible to be damaged, and thus allows a longer service life.

The embodiment of FIG. 1 particularly shows a preferred configuration of contact spring, although it should be appreciated by the person skilled in the art that the prior art contact spring and its configuration may be combined in the embodiments of the invention to yield new embodiments. In the embodiment of FIG. 1, the contact spring means comprises a pair of nested contact springs 11,11′, one ends of which rest against the stopping portion 15 and the other ends rest against a stopping member 16 fixed to the housing. The advantage of the invention lies in that the contact spring which otherwise has to be arranged outside the housing of the vacuum interrupter in the prior art due to the confined space now may be easily positioned in the receiving groove 19 of the conductive seat 12 inside the housing 1, such that a compact arrangement is provided. Accordingly, the bellows in the embodiment of the invention may also be positioned in the receiving groove 19 inside the housing 1.

In the embodiment of FIG. 1, provided in the central through-hole 20 is also a guiding bush 14 which surrounds the outer periphery of the bellows 10 and a portion of the springs 11,11′. The guiding bush 14 facilitates the contraction and stretching of the bellows, and may also perform the functionalities of protection and guide.

Furthermore, although not illustrated in the embodiments of the invention, any suitable guiding feature for the movable contact (or the movable conductive rod) which is known in the prior art or will be developed in future can be combined in the embodiments of the invention for guiding the movable contact (or movable conductive rod) of the embodiments of the invention.

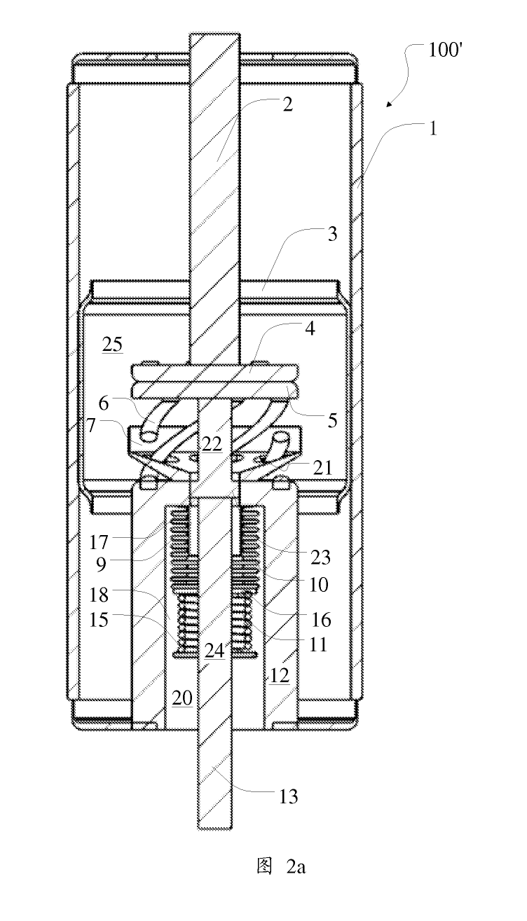

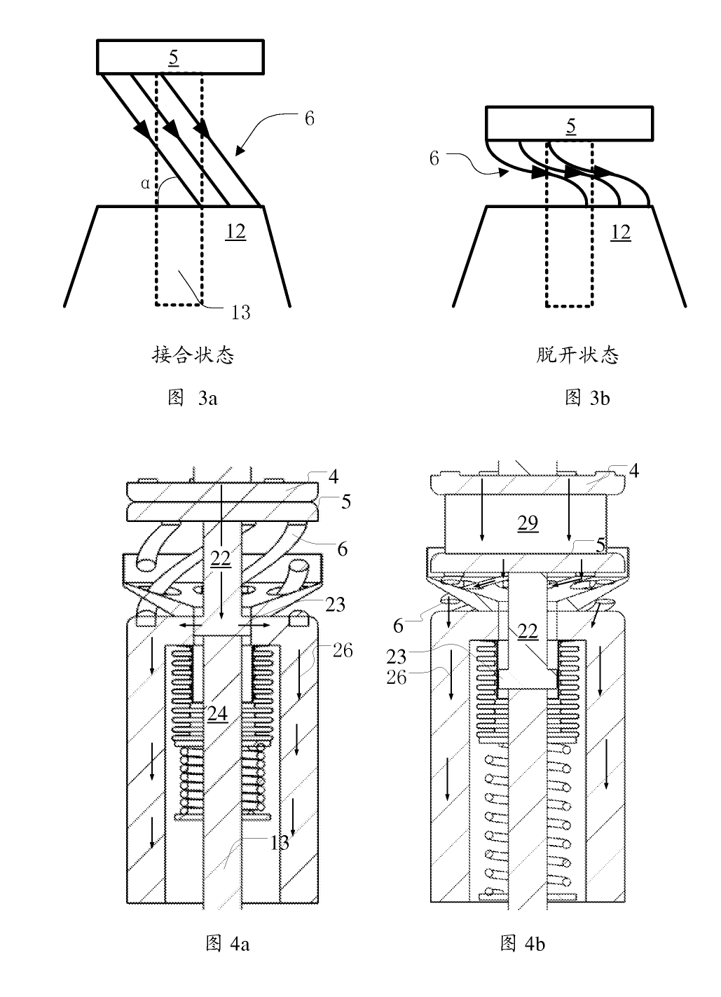

Now referring to the sectional views of FIGS. 2a, 2b, 4a and 4b the second embodiment of the vacuum interrupter 100′ of the invention is illustrated. The functions and arrangements of the components in the embodiment may refer to the first embodiment. Especially the flexible electrical connection feature may be similar to the plurality of helically flexible conductive strips in the first embodiment, or it may additionally or alternatively employ other flexible electrical connection features mentioned above, which all fall within the scope of the invention. One difference in the second embodiment lies in that the operating rod 13 also comprises a switching-on conductive feature. In the second embodiment, the switching-on conductive feature comprises a conductive top portion 22 of the operating rod 13 rod body and a conductive flange 23 extending from the rod body. Accordingly, the central through-hole 20 forms a first, upper opening portion 17 with a smaller diameter and a second, lower opening portion 18 with a greater diameter. The second, lower opening portion 18 may be the receiving groove 19 or constitute a portion of the receiving groove, or the second, lower opening portion may be formed separately from the receiving groove.

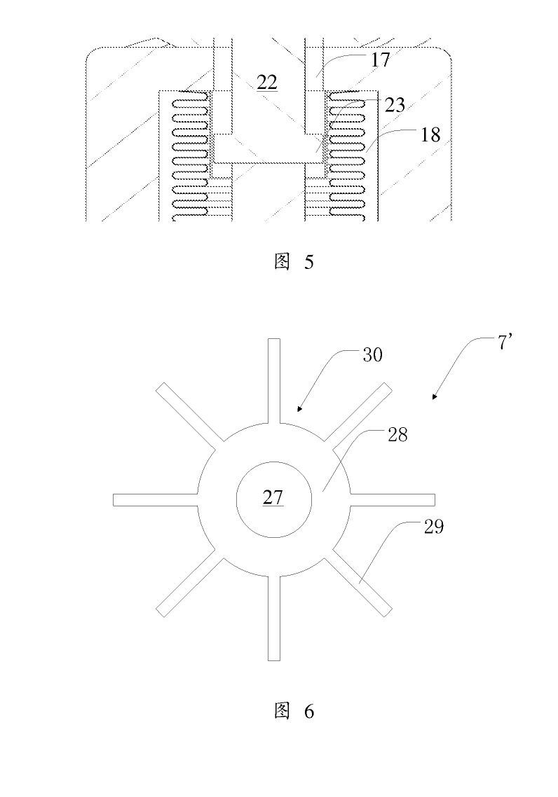

Particularly referring to FIGS. 4a and 4b, the flange 23 has a diameter corresponding to that of the first opening portion 17. When the fixed and movable contacts 4,5 switch on, the flange 23 is in surface contact in the first opening portion 17 with the conductive seat 12. Since the operating rod 13 locates in the centered position and/or it has a relatively greater cross profile, a part of, or preferably most of, or more preferably substantially all of, the current flows from the movable contact to the conductive seat 12 through the switching-on conductive feature (the top portion 22 and the flange 23) during switching on, while another part of or a relatively less part of the current flows through the flexible electrical connection feature. It is more preferred that the main current path 26 flows through the switching on conductive feature, while the current flowing through flexible electrical connection feature may be practically negligible as compared with that flowing through the switching-on conductive feature. Therefore, in the embodiment, although the invention advantageously provides many benefits by means of the flexible conductive feature, this embodiment is further able to provide comparable or even better current conductive efficiency during switching on by means of the switching-on conductive feature, as compared with the prior art design. When the fixed and movable contacts 4,5 are disengaging (switching off) from each other but a complete cut-off has not yet been realized, i.e. there is an electrical arc 29, as shown in FIG. 4b, the flange 23 now has been moved into the second opening portion 18 with the greater diameter, and thus does not contact with the conductive seat 12 (as detailed in FIG. 5). At this time, the current transfer is completely or substantially realized by means of the flexible electrical connection feature such that the main current path 26 now is formed passing through the flexible electrical connection feature. Since the switching-on conductive feature now is not working, the embodiment now will still have the advantages produced by the flexible electrical connection feature mentioned above.

Although the embodiment illustrates a specific arrangement of the switching-on conductive feature, the person skilled in the art, bearing the teachings of the invention in mind, may conceive of various configurations. The above-mentioned top portion and/or flange or any other suitable switching-on conductive features may comprise, or consist of, any suitable conductive material, but it is desired that they have an electric conductivity equivalent to, or preferably better than, the flexible conductive feature. Moreover, it should be understood that the lower portion 24 of the operating rod 12 may only serve as a part of the rod for actuating the movement of the moveable contact, and thus may have a material same as or different from that of the top portion 22 and/or flange 23, such as a material selected according to the functionality of an operating rod.

In the second embodiment, an example of another separating support 7 is particularly illustrated. This separating support 7 is mounted onto conductive seat 12, as contrary to the previous embodiment. The separating support 7 has a plurality of circumferentially formed holes 21, the number of which corresponds to the number of the flexible conductive strips, with one flexible conductive strip 6 passing through each hole 21. By means of the separating support, during the movable contact is disengaging from the fixed contact, i.e. when the flexible conductive strips 6 are being compressed, the flexible conductive strips can be separated from each other so as not to deteriorate the performance of the flexible conductive strips, such as the performance of enhancing the magnetic field. It is desired that the separating support 7 does not or substantially not constitute a current path (such as negligible in the engineering practice) through which the current flows from the movable contact to the flexible conductive strips and/or the conductive seat. Preferably, this separating support 7 may be similarly made of e.g., stainless steel and/or mounted electrically separately from the conductive seat and/or the flexible conductive strips.

Now referring to FIG. 6, another embodiment of the separating support 7′ is illustrated, which is configured to be mounted onto the conductive seat 12 in a way similar with that of the above-mentioned separating support 7 and has through-hole 27 defined by an annular portion 28. The operating rod 13 passes the through-hole. The separating support 7′ has a plurality of radial bars 29 extending radially from the annular portion, such that defined between the radial bars are spaces, through which the respective flexible conductive strip 6 (not illustrated) passes, for facilitating the separation of the flexible conductive strips.

The invention may also comprise various configuration of the separating support. Furthermore, the features of the separating support 7,7′ as shown in FIG. 2a, 2b and FIG. 6 can be combined in the separating support as shown in FIG. 1. For example mounting onto the conductive seat may be accordingly changed to mounting to the operating rod.

Referring to FIG. 2a and FIG. 2b again, in the second embodiment, a bellows bush 9 is provided inside the bellows 10 for preventing the electrical arc from burning the bellows which will otherwise cause a leakage.

In the embodiment, an interior shield 3 is also provided, which accommodates the movable contact, the fixed contact, the flexible electrical connection feature and a portion of the conductive seat under a vacuum condition, and forms the above-mentioned vacuum space 25 together with the internal space of the bellows 10. The shield 3 may be made of any suitable, known or new, material same as or different from the material of the housing 1. For example, the housing 1 and/or shield 3 may be made of ceramic and/or glass.

Moreover, in this embodiment a different spring arrangement is employed, in which he spring is a tension spring 11, with its bottom end fixed to the stopping portion 15 extending from the operating rod 13 and it stop end fixed to the stopping member 16 that is fixed to the static components in the housing, such as the conductive seat 12, such that a force for compressing the operating rod 13 and the movable contact 5 against the fixed contact 4 is applied. Moreover, various other spring arrangement may be conceivable.

The above the vacuum interrupter of several embodiments of the invention is described. It should be noted that a vacuum circuit breaker including the vacuum interrupter according to the invention also falls within the scope of the invention.

It should be understood that although the specification is described according to each embodiment, it does not mean that each embodiment only includes one single aspect of the invention. The specification described in this way is merely for the purpose of clarity. It should take the specification as a whole into consideration, such that the technical solutions of various embodiments may be combined with each other to yield other embodiments which can be understood by the person skilled in the art.

It is intended that the above description shall be interpreted as illustrative only and not limiting. Equivalence, modification, alternation or combination may be made by the person skilled in the art without departing from the spirit and principle of the invention, and thus fall within the scope of the invention.

1. A vacuum interrupter, comprising:
a housing;
a fixed contact received in the housing;
a movable contact received in the housing and configured to be movable to engage with or disengage from the fixed contact;
a conductive seat fixedly mounted in the housing and configured to maintain an electrical connection with the movable contact;
a flexible electrical connection feature received in the housing for connecting the movable contact with the conductive seat; and
an operating mechanism for actuating a movement of the movable contact.

2. The vacuum interrupter according to claim 1, wherein the conductive seat is in the form of a hollow member with a central through-hole, and the operating mechanism includes an operating rod in rigid connection with the movable contact, and an actuator configured to move at least the operating rod and the movable contact to disengage from the fixed contact, wherein the operating rod passes through the central through-hole.

3. The vacuum interrupter according to claim 1, wherein the flexible electrical connection feature includes at least one flexible conductive strip arranged between the movable contact and the conductive seat, wherein the flexible conductive strip is arranged inclinedly relative to a longitudinal axis of the movable contact, or helically around the longitudinal axis.

4. The vacuum interrupter according to claim 3, wherein the at least one flexible conductive strip includes a plurality of flexible conductive strips.

5. The vacuum interrupter according to claim 4, wherein the plurality of flexible conductive strips have a consistent inclined or helical direction.

6. The vacuum interrupter according to claim 2, wherein the operating rod comprises a switching-on conductive feature in contact or connection with the movable contact, wherein the switching-on conductive feature is configured to electrically connect with the conductive seat when the movable contact engages with the fixed contact, and to electrically disconnect or be separated from the conductive seat when the movable contact disengages from the fixed contact.

7. The vacuum interrupter according to claim 6, wherein the central through-hole of the conductive seat comprises a first opening portion with a smaller diameter and a second opening portion with a greater diameter, wherein the switching-on conductive feature includes a flange which has a shape at least partially corresponding to the first opening portion, and the flange is configured to be positioned in the first opening portion when the movable contact engages with the fixed contact and moved into the second opening portion when the movable contact disengages the fixed contact.

8. The vacuum interrupter according to claim 4, wherein the vacuum interrupter further includes a separating support for supporting and separating at least some of the plurality of flexible conductive strips.

9. The vacuum interrupter according to claim 8, wherein the separating support has a plurality of circumferentially arranged holes, one flexible conductive strip passing through each of the holes.

10. The vacuum interrupter according to claim 8, wherein the separating support has a plurality of radially extending radial bars, wherein a space is defined between the two adjacent radial bars, one flexible conductive strip passing through each space.

11. The vacuum interrupter according to claim 8, wherein the separating support is mounted onto or integral with the conductive seat or the operating rod.

12. The vacuum interrupter according to claim 2, further comprising a bellows, one end of which is in peripherally sealing connection with the operating rod, and the other end is in peripherally sealing connection with the central through-hole to define a vacuum space within the housing, wherein the interior of the bellows is in vacuum.

13. The vacuum interrupter according to claim 12, wherein a bellows bush is provided inside the bellows.

14. The vacuum interrupter according to claim 2, further comprising a contact spring for biasing the movable contact towards the fixed contact, wherein one end of the contact spring is mounted to the operating rod and the other end is mounted to a fixed part within the housing.

15. The vacuum interrupter according to claim 12, wherein the conductive seat defines a receiving groove for receiving the bellows and/or the spring.

16. The vacuum interrupter according to claim 1, further comprising an interior shield positioned inside the housing, wherein the interior shield receives the fixed contact, the movable contact, the flexible electrical connection feature and a portion of the conductive seat under a vacuum condition.

17. A vacuum circuit breaker including the vacuum interrupter of claim 1.
